(19) United States
(12) Patent Application Publication
(10) Pub. No.: US 2019/0303603 A1
(43) Pub. Date: Oct. 3, 2019

(54) LOCATION-BASED SECURITY OF STORAGE DRIVES

(71) Applicant: SEAGATE TECHNOLOGY LLC, Cupertino, CA (US)

(72) Inventors: Timothy John COURTNEY, Longmont, CO (US); Saheb BISWAS, Boulder, CO (US); Kevin Gautam STERNBERG, Longmont, CO (US); Muhammad Mohsin AWAN, Lafayette, CO (US); David Michael SEESDORF, Longmont, CO (US)

(73) Assignee: SEAGATE TECHNOLOGY LLC, Cupertino, CA (US)

(21) Appl. No.: 15/944,456

(22) Filed: Apr. 3, 2018

(51) Int. Cl. G06F 21/62; G06F 3/06; G06F 12/14; H04L 29/06; H04W 4/021; H04W 4/80; H04L 9/06

(52) U.S. Cl. CPC G06F 21/6218; G06F 3/0622; G06F 3/0634; G06F 3/067; G06F 12/1416; G06F 2221/2111; H04W 4/021; H04W 4/80; H04L 9/0637; H04L 2463/082; H04L 2209/38; H04L 63/107

(57) ABSTRACT

Systems and methods for location-based security of storage drives are described. In one embodiment, the systems may include a storage drive and a hardware controller. In some embodiments, the hardware controller may be configured to determine a location of the storage drive; identify a current mode of the storage drive, the storage drive including at least a secure mode and a non-secure mode; block activation of the secure mode upon determining that the storage drive is located in one of one or more non-permitted areas or not located in one of one or more permitted areas; and put the storage drive in the non-secure mode upon determining the storage drive is located in one of the one or more non-permitted areas while in the secure mode.

### SUMMARY

The present disclosure is directed to methods and systems for location-based security of storage drives. In some embodiments, the present systems and methods may control access to one or more areas of a storage drive based at least in part on a detected location of the storage drive. Additionally or alternatively, the present systems and methods may control access to one or more areas of a storage drive based at least in part on a detectable proximity between the storage drive and a separate computing device and/or a detectable proximity between the storage drive and sensor external to and independent of the storage drive.

A storage system for location-based security of storage drives is described. In one embodiment, the storage system may include a storage drive and a hardware controller. In some embodiments, the hardware controller may be configured to determine a location of the storage drive; identify a current mode of the storage drive, the storage drive including at least a secure mode and a non-secure mode; block activation of the secure mode upon determining that the storage drive is located in one of one or more non-permitted areas or not located in one of one or more permitted areas; and put the storage drive in the non-secure mode upon determining the storage drive is located in one of the one or more non-permitted areas while in the secure mode.

In some embodiments, the hardware controller may be configured to unlock at least a portion of storage on the storage drive based at least in part on determining the storage drive is located in one of the one or more permitted areas.

In some embodiments, the hardware controller may be configured to unlock at least the portion of storage on the storage drive upon determining the storage drive is located in one of the one or more permitted areas and within detectable proximity of a pre-authorized device. In some cases, the storage drive or the pre-authorized drive, or both, may include a near field communication (NFC) sensor to detect the proximity between the storage drive and the pre-authorized device.

In some embodiments, the hardware controller may be configured to unlock the at least portion of storage on the storage drive based at least in part on validating a multi-factor authentication. In some embodiments, at least one factor in the multi-factor authentication may include placing the storage drive within detectable proximity of the pre-authorized device.

In some embodiments, the hardware controller may be configured to lock the at least portion of storage upon determining the storage drive is removed from one of the one or more permitted areas or enters one of the one or more non-permitted areas. In some embodiments, the hardware controller may be configured to update an event ledger upon detecting the location of the storage drive, wherein the event ledger is stored in a blockchain of a cloud storage system.

In some embodiments, the hardware controller may be configured to program the one or more permitted areas or the one or more non-permitted areas, or both, at a manufacturing site of the storage drive; disable at least one of the permitted areas programmed at the manufacturing site or at least one of the non-permitted areas programmed at the manufacturing site, or both; and program at least one user customized permitted area, or at least one user customized non-permitted area, or both.

In some embodiments, the hardware controller may be configured to validate the determined location of the storage drive, the validating including signing a global positioning system (GPS) packet with a private key and verifying the GPS packet using a public key.

A method to improve a storage system is also described. In one embodiment, the method may include determining a location of the storage drive; identifying a current mode of the storage drive, the storage drive including at least a secure mode and a non-secure mode; blocking activation of the secure mode upon determining that the storage drive is located in one of one or more non-permitted areas or not located in one of one or more permitted areas; and putting the storage drive in the non-secure mode upon determining the storage drive is located in one of the one or more non-permitted areas while in the secure mode.

A computer-program product to improve a storage system is also described. In one embodiment, the computer-program product includes a non-transitory computer-readable medium storing instructions thereon. In some cases, the instructions may be executable by one or more processors to perform the steps of determining a location of the storage drive; validating the determined location of the storage drive; identifying a current mode of the storage drive, the storage drive including at least a secure mode and a non-secure mode; blocking activation of the secure mode upon determining that the storage drive is located in one of one or more non-permitted areas or not located in one of one or more permitted areas; and putting the storage drive in the non-secure mode upon determining the storage drive is located in one of the one or more non-permitted areas while in the secure mode.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, including their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components, including those having a dash and a second reference label, apply to other similar components. If only the first reference label is used in the specification, the description is applicable to any one of the similar components having the same first reference label irrespective of the second reference label.

FIG. 1 is a block diagram of an example of a system in accordance with various embodiments;

FIG. 2 shows a block diagram of a device in accordance with various aspects of this disclosure;

FIG. 3 shows a block diagram of one or more modules in accordance with various aspects of this disclosure;

FIG. 4 shows a diagram of a system in accordance with various aspects of this disclosure;

FIG. 5 shows one embodiment of an environment in accordance with various aspects of this disclosure;

FIG. 6 is a flow chart illustrating an example of a method in accordance with various aspects of this disclosure; and

FIG. 7 is a flow chart illustrating an example of a method in accordance with various aspects of this disclosure.

### DETAILED DESCRIPTION

The following relates generally to location-based security of storage drives. In one embodiment, a storage drive may include a self-encrypting drive (SED). In some embodiments, the storage drive may be configured to determine its location. In some cases, the storage drive may include at least one of a global positioning system (GPS) sensor, a local positioning system (LPS) sensor, or any combination thereof. In some embodiments, the GPS sensor may include a secure GPS sensor. In some embodiments, the LPS sensor may include a secure LPS sensor. In one embodiment, GPS packets received by the storage drive may be signed with a private key (e.g., Rivest Shamir Adleman (RSA) key, etc.). In some cases, the storage drive may use a public key to validate the signed GPS packets. In one embodiment, LPS packets received by the storage drive may be signed with a private key (e.g., RSA key, etc.). In some cases, the storage drive may use a public key to validate the signed LPS packets.

In some cases, one or more features of the storage drive may be enabled based on a validated location of the storage drive. In some cases, one or more features of the storage drive may be enabled upon determining the storage drive is in one of one or more pre-programmed GPS and/or LPS regions where the one or more features are allowed. In some cases, one or more features of the storage drive may be disabled upon determining the storage drive is in one of one or more pre-programmed GPS and/or LPS regions where the one or more features are blocked. The one or more features may include at least one of reading data from one or more particular storage locations, writing data to one or more particular storage locations, granting access to one or more particular storage locations, encrypting data being written to the storage drive, decrypting encrypted data written to the storage drive, locking the storage drive, unlocking the storage drive, or any combination thereof.

In some cases, a first set of features may be enabled in a first allowed area and a second set of features may be enabled in a second allowed area, where at least one feature from the second set of features is different than or not included in the features of the first set. Additionally or alternatively, a first set of features may be disabled in a first non-allowed area and a second set of features may be disabled in a second non-allowed area, where at least one feature from the second set of features is different than or not included in the features of the first set.

In one embodiment, the storage drive may include two or more modes. For example, the storage drive may be configured to operate in a secure mode and a non-secure mode. In some cases, non-secure mode may include operating the storage drive in a default mode where one or more settings of the storage drive are set to default values. In one embodiment, when the storage drive is in the non-secure mode the storage drive may operate without data protection or encryption of data. In one embodiment, enabling the secure mode may include applying one or more passwords to the storage drive and/or assigning one or more authorized users of the storage drive. In some cases, operating in the secure mode may include unlocking at least a portion of storage on the storage drive for reading data and/or writing data to the storage drive. In some cases, operating in the secure mode may include enabling encryption of data being written to the storage drive.

In one embodiment, upon determining the storage drive is determined to be in a non-allowed area and the storage drive is in a non-secure mode, the storage drive may be configured to block the secure mode being activated. In one embodiment, when the storage drive is determined to be in a non-allowed area and the storage drive is in the secure mode then the storage drive may be configured to disable the secure mode.

In one embodiment, the storage drive may be configured to operate based at least in part on multi-factor authentication. Satisfying each of the factors of authentication may enable one or more features of the storage drive. In some cases, satisfying each of the factors may enable the secure mode of the storage drive. In some embodiments, failing to satisfy each of the factors of authentication may disable one or more features of the storage drive. In some embodiments, failing to satisfy each of the factors of authentication may block the storage drive from operating in secure mode and switch or keep the storage drive in non-secure mode. In one embodiment, authenticating the factors may include at least one of validating password credentials, validating a location of the storage drive, verifying a detectable proximity between the storage drive and a computing device, or any combination thereof.

In one embodiment, the storage drive may be configured to log events associated with the storage drive in an even ledger. In one embodiment the event ledger may be stored in a blockchain. In some cases, the events being logged may include read operations, write operations, encrypting data, locking the storage drive, unlocking the storage drive, and/or making at least a portion of storage available for data writes.

In one embodiment, the storage drive may include one or more hardware sensors that enable the storage drive to modify drive capabilities and/or drive behaviors at runtime based at least in part on data generated by the hardware sensors. The hardware sensors may include GPS sensors, near field communications (NFC) sensors, proximity sensors, induction sensor, etc. As one example the storage drive may be configured to enable one or more features when the storage drive is determined to be inside a geo-fenced building. As another example, the storage drive may be configured to unlock certain bands of a shingled magnetic recording (SMR) drive when the proximity sensor in the drive detects the presence of a pre-authorized device such as a computing device (e.g., desktop computer, laptop computer, mobile computing device, server, networking device, etc.).

In some cases, the storage drive may be configured to erase data stored to the storage drive based at least in part on data generated by the hardware sensors. For example, the storage drive may be configured to erase data upon determining the GPS sensor indicates the storage drive is outside an allowed area or inside a non-allowed area. In some cases, the storage drive may be configured to revert to a default manufactured state based at least in part on data generated by the hardware sensors. Reverting to a default manufactured state may include at least one of erasing data on the storage drive, configuring one or more settings of the storage drive to a default state, erasing passwords, removing associations between the storage drive and one or more users, or any combination thereof. In some cases, erasing data and/or reverting the storage drive to a manufactured state may be enabled only when each factor of multi-factor authentication is satisfied.

In one embodiment, geo-fencing may be programmed into the storage drive at the time of manufacturing the drive. In some cases, at least a portion of the manufacturer geo-fencing may be disabled by an end user of the storage drive. In some cases, the end user may implement customized geo-fencing on the storage drive.

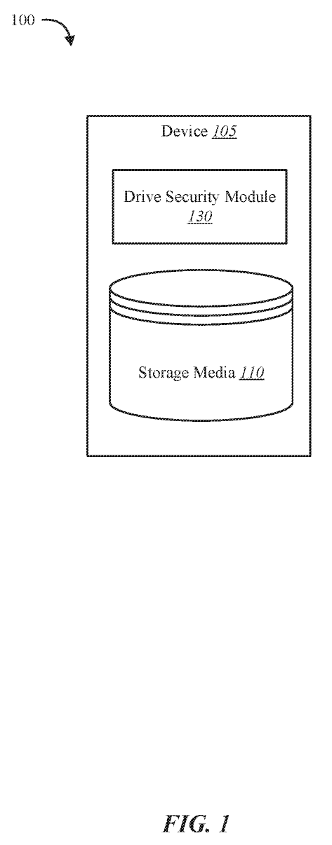

FIG. 1 is a block diagram illustrating one embodiment of an environment 100 in which the present systems and methods may be implemented. The environment may include device 105 and storage media 110. The storage media 110 may include any combination of hard disk drives, solid state drives, and hybrid drives that include both hard disk and solid state drives. In some embodiments, the storage media 110 may include shingled magnetic recording (SMR) storage drives. In some embodiments, the systems and methods described herein may be performed on a single device such as device 105. In some cases, the methods described herein may be performed on multiple storage devices or a network of storage devices such a cloud storage system and/or a distributed storage system. Examples of device 105 include a storage server, a storage enclosure, a storage controller, storage drives in a distributed storage system, storage drives on a cloud storage system, storage devices on personal computing devices, storage devices on a server, or any combination thereof. In some configurations, device 105 may include drive security module 130. In one example, the device 105 may be coupled to storage media 110. In some embodiments, device 105 and storage media 110 may be components of flash memory or a solid state drive and/or another type of storage drive. Alternatively, device 105 may be a component of a host of the storage media 110 such as an operating system, host hardware system, or any combination thereof.

In one embodiment, device 105 may be a computing device with one or more processors, memory, and/or one or more storage devices. In some cases, device 105 may include a wireless storage device. In some embodiments, device 105 may include a cloud drive for a home or office setting. In one embodiment, device 105 may include a network device such as a switch, router, access point, or any combination thereof. In one example, device 105 may be operable to receive data streams, store and/or process data, and/or transmit data from, to, or in conjunction with one or more local and/or remote computing devices.

The device 105 may include a database. In some cases, the database may be internal to device 105. In some embodiments, storage media 110 may include a database. Additionally, or alternatively, device 105 may include a wired and/or a wireless connection to an external database. Additionally, as described in further detail herein, software and/or firmware (for example, stored in memory) may be executed on a processor of device 105. Such software and/or firmware executed on the processor may be operable to cause the device 105 to monitor, process, summarize, present, and/or send a signal associated with the operations described herein.

In some embodiments, storage media 110 may connect to device 105 via one or more networks. Examples of networks include cloud networks, local area networks (LAN), wide area networks (WAN), virtual private networks (VPN), a personal area network, near-field communication (NFC), a telecommunications network, wireless networks (using 802.11, for example), and cellular networks (using 3G and/or LTE, for example), or any combination thereof. In some configurations, the network may include the Internet and/or an intranet. The device 105 may receive and/or send signals over a network via a wireless communication link. In some embodiments, a user may access the functions of device 105 via a local computing device, remote computing device, and/or network device. For example, in some embodiments, device 105 may include an application that interfaces with a user. In some cases, device 105 may include an application that interfaces with one or more functions of a network device, remote computing device, and/or local computing device.

In one embodiment, the storage media 110 may be internal to device 105. As one example, device 105 may include a storage controller that interfaces with storage media of storage media 110. Drive security module 130 may determine a location of a storage drive and determine whether a certain operation of on the storage drive is permitted in the determined location. Additionally or alternatively, drive security module 130 may determine whether certain storage space on the storage drive is permitted to be accessed in the determined location.

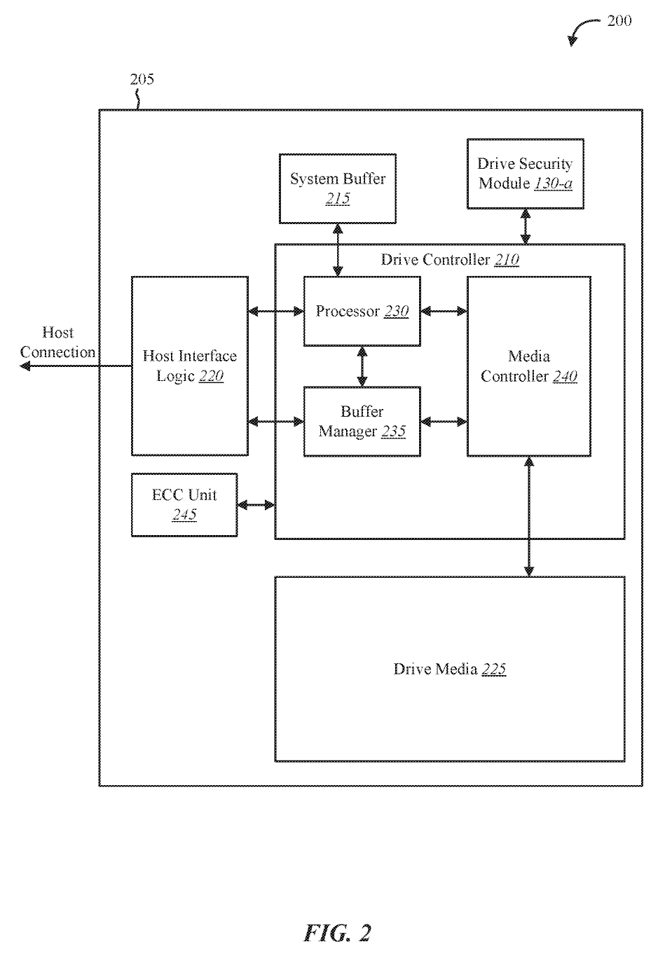

FIG. 2 shows a block diagram 200 of an apparatus 205 for use in electronic communication, in accordance with various aspects of this disclosure. The apparatus 205 may be an example of one or more aspects of device 105 described with reference to FIG. 1. The apparatus 205 may include a drive controller 210, system buffer 215, host interface logic 220, drive media 225, and drive security module 130-a. Each of these components may be in communication with each other and/or other components directly and/or indirectly.

One or more of the components of the apparatus 205, individually or collectively, may be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used such as Structured/Platform ASICs, Field Programmable Gate Arrays (FPGAs), and other Semi-Custom ICs, which may be programmed in any manner known in the art. The functions of each module may also be implemented, in whole or in part, with instructions embodied in memory formatted to be executed by one or more general and/or application-specific processors.

In one embodiment, the drive controller 210 may include a processor 230, a buffer manager 235, and a media controller 240. The drive controller 210 may process, via processor 230, read and write requests in conjunction with the host interface logic 220, the interface between the apparatus 205 and the host of apparatus 205. The system buffer 215 may hold data temporarily for internal operations of apparatus 205. For example, a host may send data to apparatus 205 with a request to store the data on the drive media 225. Drive media 225 may include one or more disk platters, flash memory, any other form of non-volatile memory, or any combination thereof. The drive controller 210 may process the request and store the received data in the drive media 225. In some cases, a portion of data stored in the drive media 225 may be copied to the system buffer 215 and the processor 230 may process or modify this copy of data and/or perform an operation in relation to this copy of data held temporarily in the system buffer 215. In some cases, error correction code (ECC) unit 245 may perform error correction on data stored in drive media 225.

In some embodiments, drive security module 130-a may include at least one of one or more processors, one or more memory devices, one or more storage devices, instructions executable by one or more processors stored in one or more memory devices and/or storage devices, or any combination thereof. Although depicted outside of drive controller 210, in some embodiments, drive security module 130-a may include software, firmware, and/or hardware located within drive controller 210 and/or operated in conjunction with drive controller 210. For example, drive security module 130-a may include at least a portion of processor 230, buffer manager 235, and/or media controller 240. In one example, drive security module 130-a may include one or more instructions executed by processor 230, buffer manager 235, and/or media controller 240.

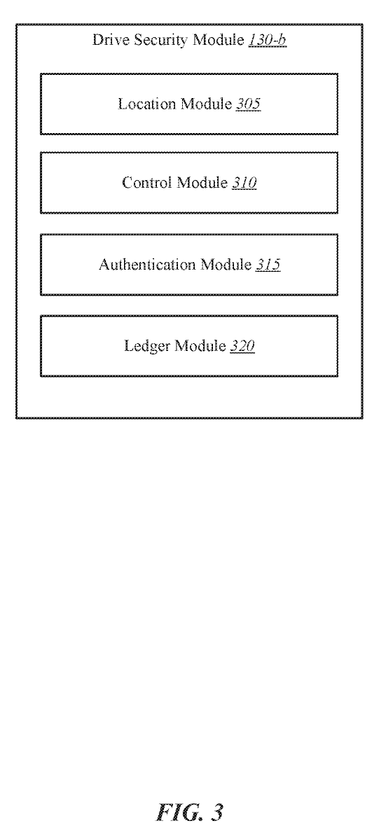

FIG. 3 shows a block diagram of drive security module 130-b. The drive security module 130-b may include one or more processors, memory, and/or one or more storage devices. The drive security module 130-b may include location module 305, control module 310, authentication module 315, and ledger module 320. The drive security module 130-b may be one example of drive security module 130 of FIGS. 1 and/or 2. Each of these components may be in communication with each other.

In one embodiment, drive security module 130-b may include and/or perform one or more operations in conjunction with one or more computing devices, each computing device having one or more processors each. In some cases, drive security module 130-b may include and/or perform one or more operations in conjunction with one or more storage drives, each storage drive having one or more hardware controllers each.

In one embodiment, location module 305 may be configured to determine a location of a storage drive. In some cases, the storage drive may include a self-encrypting drive. In some cases, the storage drive may identify a current mode of the storage drive. In some cases, the storage drive may include at least a secure mode and a non-secure mode. In some embodiments, the secure mode may be associated with one or more authentication factors used to unlock the storage drive (e.g., password, device identifier, etc.). Unlocking the storage drive may include unlocking access to a predetermined portion of storage medium on the storage drive and/or unlocking features of the storage drive (e.g., encryption of data writes to the storage drive, decryption of encrypted data stored on the storage drive, etc.).

In some cases, secure mode may include the storage drive being designated for use to one or more users. In some cases, each designated user may have credentials that must be authenticated in order to access the storage drive and/or enable the secure mode. In some cases, the secure mode may include enabling encryption of data stored to the storage drive and/or encrypted data on the storage drive being made accessible by the validation of one or more authentication factors.

In one embodiment, control module 310 may be configured to block activation of the secure mode upon determining that the storage drive is located in one of one or more non-permitted areas or not located in one of one or more permitted areas.

In some embodiments, control module 310 may be configured to put the storage drive in the non-secure mode upon determining the storage drive is located in one of the one or more non-permitted areas while in the secure mode. In some cases, the storage drive may be configured with geo-fencing that stipulates geographic locations or areas where the drive is permitted to operate in secure mode and/or geo-fencing that stipulates geographic locations or areas where the drive is not permitted to operate in secure mode. In some embodiments, control module 310 may be configured to take the storage drive out of secure mode and put the storage drive in the non-secure mode. In the non-secure mode, the storage drive may be configured to write data to its storage medium and/or read data written to its storage medium. However, in the non-secure mode, the storage drive may be configured to deny encryption of data being written to the storage drive and/or deny access to encrypted data stored on the storage medium.

In some embodiments, control module 310 may be configured to unlock access to at least a portion of storage on the storage drive based at least in part on determining the storage drive is located in one of the one or more permitted areas. In some cases, unlocking access to at least a portion of storage on the storage drive may include unlocking one or more bands of a shingled magnetic recording (SMR) hard drive. In some cases, unlocking access to at least a portion of storage on the storage drive may include unlocking access to encrypted data stored on the storage drive. In some cases, unlocking access to at least a portion of storage on the storage drive may enabling encryption of data written to the storage drive.

In some embodiments, control module 310 may be configured to unlock at least the portion of storage on the storage drive upon determining the storage drive is located in one of the one or more permitted areas and within detectable proximity of at least one pre-authorized device. In some cases, the storage drive or the pre-authorized drive, or both, includes a near field communication (NFC) sensor to detect the proximity between the storage drive and at least one pre-authorized device.

In one embodiment, authentication module 315 may be configured to validate a multi-factor authentication. In some cases, control module 310 may be configured to unlock at least a portion of storage on the storage drive based at least in part on authentication module 315 validating multi-factor authentication. At least one factor in the multi-factor authentication may include placing the storage drive within detectable proximity of at least one pre-authorized device. For example, one factor of the multi-factor authentication may include placing the storage drive in proximity of a first pre-authorized device and/or placing the storage drive in proximity of a second pre-authorized device. Examples of factors may include validating password credentials, validating a location of the storage drive, determining the storage drive is in a permitted area, detecting that a first device is placed within a detectable proximity of a second device (e.g., placing a mobile device within detectable proximity of a storage drive, etc.), validating a response is sent by a predetermined device, identifying a device identifier in a message from a particular device indicating a factor is sent by a particular device, or any combination thereof. In some cases, a first factor may include the storage drive detecting a pre-authorized device within a detectable proximity, and a second factor may include the pre-authorized device sending the storage device a message acknowledging the detected proximity.

In one embodiment, authentication module 315 may be configured to validate the determined location of the storage drive, the validating including signing a global positioning system (GPS) packet with a private key and verifying the GPS packet using a public key.

In some embodiments, control module 310 may be configured to keep the at least portion of storage locked upon determining the multi-factor authentication fails. In some cases, control module 310 may be configured to lock the at least portion of storage upon determining the storage drive is removed from one of the one or more permitted areas or enters one of the one or more non-permitted areas. In some cases, the data stored to the storage drive while in a permitted area may be erased and/or destroyed upon detecting the storage drive leaving the permitted area and/or upon detecting the storage drive entering a non-permitted area. In some cases, an encryption key used to encrypt data stored to the storage drive while in a permitted area may be destroyed upon detecting the storage drive leaving the permitted area and/or upon detecting the storage drive entering a non-permitted area, resulting in the data encrypted by the encrypted key being made permanently inaccessible.

In some embodiments, ledger module 320 may be configured to update an event ledger upon detecting the location of the storage drive. In some cases, the event ledger may be stored in a blockchain of a cloud storage system. In some cases, one or more events associated with the storage drive may be stored in the event ledger. Recorded events may include a detected location of the storage drive, locking the storage drive, unlocking the storage drive, enabling encryption on the storage drive, decrypting encrypted data stored on the storage drive, disabling encryption on the storage drive, adding a password to the storage drive, updating a password of the storage drive, destroying an encryption key associated with the storage drive, updating a permitted area, updating a non-permitted area, adding a permitted area, adding a non-permitted area, removing a permitted area, removing a non-permitted area, customizing a permitted area, customizing a non-permitted area, or any combination thereof.

In some embodiments, control module 310 may be configured to program the one or more permitted areas and/or program the one or more non-permitted areas at the time of manufacturing. For example, control module 310 may be configured to program the one or more permitted areas and/or program the one or more non-permitted areas at a manufacturing site of the storage drive at the time of manufacturing.

In some embodiments, control module 310 may be configured to disable at least one of the permitted areas previously programmed at the manufacturing site and/or disable at least one of the non-permitted areas previously programmed at the manufacturing site. For example, control module 310 may be configured to disable a permitted area and/or disable a non-permitted area after the storage drive is received by an end-user. In some embodiments, control module 310 may be configured to program at least one user customized permitted area and/or program at least one user customized non-permitted area after the storage drive is received by an end-user.

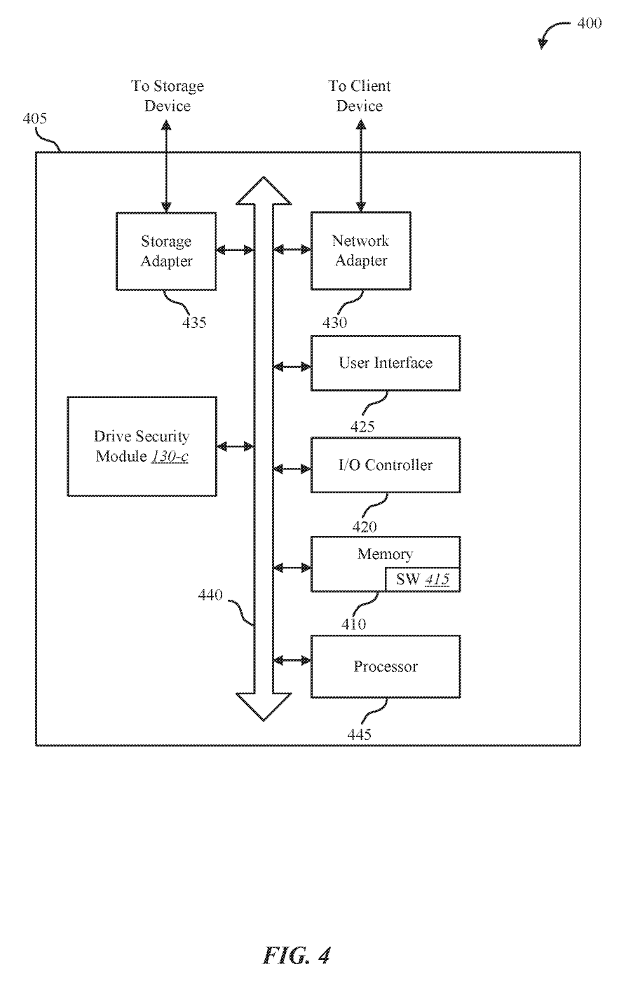

FIG. 4 shows a system 400 for location-based security of storage drives, in accordance with various examples. System 400 may include an apparatus 405, which may be an example of any one of device 105 of FIG. 1 and/or apparatus 205 of FIG. 2.

Apparatus 405 may include components for bi-directional voice and data communications including components for transmitting communications and components for receiving communications. For example, apparatus 405 may communicate bi-directionally with one or more storage devices and/or client systems. This bi-directional communication may be direct (apparatus 405 communicating directly with a storage system, for example) and/or indirect (apparatus 405 communicating indirectly with a client device through a server, for example).

Apparatus 405 may also include a processor module 445, and memory 410 (including software/firmware code (SW) 415), an input/output controller module 420, a user interface module 425, a network adapter 430, and a storage adapter 435. The software/firmware code 415 may be one example of a software application executing on apparatus 405. The network adapter 430 may communicate bi-directionally, via one or more wired links and/or wireless links, with one or more networks and/or client devices. In some embodiments, network adapter 430 may provide a direct connection to a client device via a direct network link to the Internet via a POP (point of presence). In some embodiments, network adapter 430 of apparatus 405 may provide a connection using wireless techniques, including digital cellular telephone connection, Cellular Digital Packet Data (CDPD) connection, digital satellite data connection, and/or another connection. The apparatus 405 may include drive security module 130-c, which may perform the functions described above for the drive security module 130 of FIGS. 1, 2, and/or 3.

The signals associated with system 400 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network adapter 430 may enable one or more of WWAN (GSM, CDMA, and WCDMA), WLAN (including BLUETOOTH® and Wi-Fi), WMAN (WiMAX) for mobile communications, antennas for Wireless Personal Area Network (WPAN) applications (including RFID and UWB), or any combination thereof.

One or more buses 440 may allow data communication between one or more elements of apparatus 405 such as processor module 445, memory 410, I/O controller module 420, user interface module 425, network adapter 430, and storage adapter 435, or any combination thereof.

The memory 410 may include random access memory (RAM), read only memory (ROM), flash memory, and/or other types. The memory 410 may store computer-readable, computer-executable software/firmware code 415 including instructions that, when executed, cause the processor module 445 to perform various functions described in this disclosure. Alternatively, the software/firmware code 415 may not be directly executable by the processor module 445 but may cause a computer (when compiled and executed, for example) to perform functions described herein. Alternatively, the computer-readable, computer-executable software/firmware code 415 may not be directly executable by the processor module 445, but may be configured to cause a computer, when compiled and executed, to perform functions described herein. The processor module 445 may include an intelligent hardware device, for example, a central processing unit (CPU), a microcontroller, an application-specific integrated circuit (ASIC), field programmable gate array (FPGA), or any combination thereof.

In some embodiments, the memory 410 may contain, among other things, the Basic Input-Output system (BIOS) which may control basic hardware and/or software operation such as the interaction with peripheral components or devices. For example, at least a portion of the drive security module 130-c to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface such as network adapter 430.

Many other devices and/or subsystems may be connected to and/or included as one or more elements of system 400 (for example, a personal computing device, mobile computing device, smart phone, server, internet-connected device, cell radio module, or any combination thereof). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be a mobile device operation system, a desktop/laptop operating system, or another known operating system.

The I/O controller module 420 may operate in conjunction with network adapter 430 and/or storage adapter 435. The network adapter 430 may enable apparatus 405 with the ability to communicate with client devices such as device 105 of FIG. 1, and/or other devices over a communication network. Network adapter 430 may provide wired and/or wireless network connections. In some cases, network adapter 430 may include an Ethernet adapter or Fibre Channel adapter. Storage adapter 435 may enable apparatus 405 to access one or more data storage devices such as storage media 110. The one or more data storage devices may include two or more data tiers each. The storage adapter 435 may include one or more of an Ethernet adapter, a Fibre Channel adapter, Fibre Channel Protocol (FCP) adapter, a SCSI adapter, and iSCSI protocol adapter.

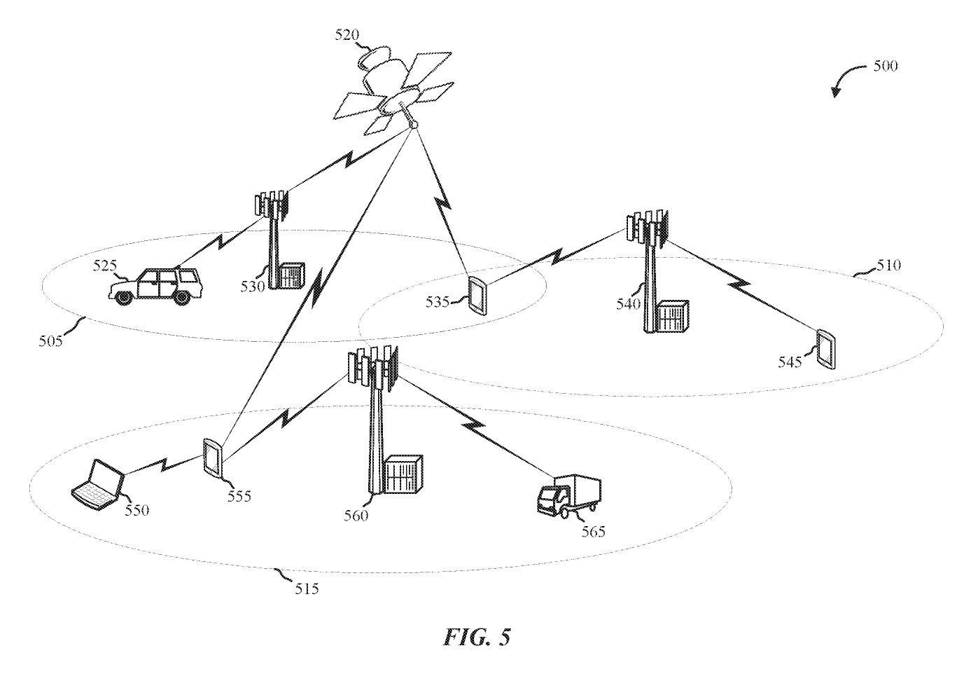

FIG. 5 shows an environment 500 for location-based security of storage drives, in accordance with various examples. At least one aspect of environment 500 may be implemented in conjunction with device 105 of FIG. 1, apparatus 205 of FIG. 2, and/or drive security module 130 depicted in FIGS. 1, 2, 3, and/or 4.

As depicted, environment 500 may include a first permitted area 505, a non-permitted area 510, a second permitted area 515, and a global positioning system (GPS) satellite 520. Although depicting a certain number of permitted and non-permitted areas, it is understood that environment 500 may include less or more permitted and/or non-permitted areas than those shown in FIG. 5. As illustrated, first permitted area 505 may include a first vehicle 525, a first local positioning system (LPS) radio 530, and a first computing device 535. As shown, non-permitted area 510 may also include first computing device 535, second LPS radio 540, and second computing device 545. As illustrated, second permitted area 515 may include third computing device 550, fourth computing device 555, third LPS radio 560, and second vehicle 565.

As illustrated, at least one of LPS radio 530, 540, and/or 560 may include a cellular communication tower. In some cases, at least one of LPS radio 530, 540, and/or 560 may include other types of LPS beacons, receivers, transmitters, transceivers, transponders, etc., to enable a device to determine its local position. In some cases, at least one of LPS radio 530, 540, and/or 560 may include a near-field communication (NFC) radio and/or proximity sensor. In one example, a storage drive may determine its local location based at least in part on triangulation analysis of wireless and/or cellular signals from at least one of LPS radio 530, 540, and/or 560. In some cases, at least one of LPS radio 530, 540, and/or 560 may emit a location signal indicating the coordinates of the particular LPS radio. For example, LPS radio 530 may emit a signal to first vehicle 525 indicating the location of LPS radio 530.

In one embodiment, one or more devices may establish a communication link with GPS satellite 520. For example, as shown first computing device 535 and fourth computing device 555 may establish communication links, respectively, with GPS satellite 520. In some cases, other devices such as second computing device 545 and third computing device 550 may establish communication links, respectively, with GPS satellite 520. In some embodiment, first vehicle 525 and/or second vehicle 565 may establish communication links, respectively, with GPS satellite 520. In some cases, at least one of LPS radio 530, 540, and/or 560 may communicate with GPS satellite 520.

In one embodiment, one or more devices and/or vehicles depicted in environment 500 may include at least one storage drive. For example, first vehicle 525 and/or second vehicle 565 may each include one or more storage drives. Although environment depicts a road vehicle, environment 500 may include other types of transportation such as airplanes, boats, etc. Thus, a road vehicle, boat, plane, or other type of transportation may include a storage drive. Additionally or alternatively, at least one of first computing device 535, second computing device 545, third computing device 550, and/or fourth computing device 555 may each include one or more storage drives. In one example, GPS satellite 520 may communicate with at least one of LPS radios 530, 540, and/or 560.

In one embodiment, a location of a storage drive may be determined based at least in part on a GPS signal from GPS satellite 520 and/or an LPS signal from at least one of LPS radios 530, 540, and/or 560. In some cases, a location of a storage device may be based on both GPS and LPS. In some embodiments, a storage drive in a vehicle and/or computing device shown in environment 500 may determine its location and permit or deny an operation of the storage drive based on its determined location. In some cases, a storage drive in a vehicle and/or computing device shown in environment 500 may permit or deny access to one or more storage areas of the storage drive based on its determined location. For example, a computing device within a vehicle may have a storage drive that determines its location and allows an operation and/or access to storage space upon determining the storage drive is in a permitted area.

In one embodiment, first vehicle 525 may include a storage drive that determines its location is within first permitted area 505. Upon determining the storage drive of first vehicle 525 is within first permitted area 505, the storage drive may permit one or more operations and/or allow access to one or more storage spaces of the storage drive. In some cases, the storage drive in first vehicle 525 may determine that the storage drive is within a detectable proximity of an external computing device and permit one or more operations or allow access to storage space upon verifying the detectable proximity. In some cases, the other computing device may be within first vehicle 525 or outside first vehicle 525. For example, the other computing device may be in first LPS radio 530, in another vehicle within first permitted area 505, etc.

In some cases, a permitted area may overlap a non-permitted area. For example, an edge of a permitted area may cross over an edge of a non-permitted area. Additionally or alternatively, overlap may occur when a permitted area is embedded within a non-permitted area. In some cases, overlap may occur when a non-permitted area is embedded within a permitted area. In some cases, when a storage drive enters a permitted area that overlaps a non-permitted area, the permitted area may take precedence over the non-permitted area and the storage drive may remain in or be allowed to enter secure mode. Alternatively, when a storage drive in secure mode enters a permitted area that overlaps a non-permitted area, the non-permitted area may take precedence over the permitted area and the storage drive may be kept in non-secure mode or removed from secure mode and placed in non-secure mode. As depicted, first computing device 535 may include a storage drive that determines its location is in both the first permitted area 505 and non-permitted area 510. Thus, in one embodiment, the storage drive of first computing device 535 may be allowed to enter or may remain in secure mode. Alternatively, the storage drive of first computing device 535 may be kept in non-secure mode or removed from secure mode and placed in non-secure mode.

In one embodiment, when a storage drive is in a permitted area and within a detectable proximity of a predetermined external device, the storage drive may be allowed to be in secure mode or kept in secure mode. In some embodiments, when a storage drive is in a permitted area, but not within a detectable proximity of a predetermined external device, the storage drive may be placed in non-secure mode or kept in non-secure mode. As shown, third computing device 550 may be in detectable proximity to fourth computing device 555. Thus, a storage drive in third computing device 550 may determine that the storage drive is within detectable proximity of fourth computing device 555 and permit one or more operations or allow access to storage space upon verifying the detectable proximity. Additionally or alternatively, a storage drive in fourth computing device 555 may determine that the storage drive is within detectable proximity of third computing device 550 and permit one or more operations or allow access to storage space upon verifying the detectable proximity. In some embodiments, when a storage drive is in a permitted area, but not within a detectable proximity of a predetermined external device, the storage drive may be placed in non-secure mode or kept in non-secure mode.

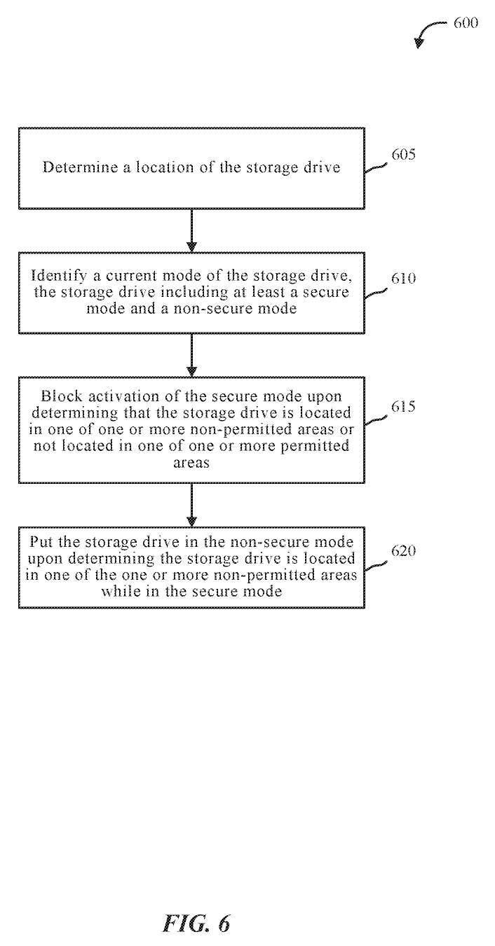

FIG. 6 is a flow chart illustrating an example of a method 600 for location-based security of storage drives, in accordance with various aspects of the present disclosure. One or more aspects of the method 600 may be implemented in conjunction with device 105 of FIG. 1, apparatus 205 of FIG. 2, and/or drive security module 130 depicted in FIGS. 1, 2, 3, and/or 4. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 605, method 600 may include determining a location of the storage drive. At block 610, method 600 may include identifying a current mode of the storage drive, the storage drive including at least a secure mode and a non-secure mode.

At block 615, method 600 may include blocking activation of the secure mode upon determining that the storage drive is located in one of one or more non-permitted areas or not located in one of one or more permitted areas. At block 620, method 600 may include putting the storage drive in the non-secure mode upon determining the storage drive is located in one of the one or more non-permitted areas while in the secure mode.

The operation(s) at block 605-620 may be performed using the drive security module 130 described with reference to FIGS. 1-4 and/or another module. Thus, the method 600 may provide for location-based security of storage drives. It should be noted that the method 600 is just one implementation and that the operations of the method 600 may be rearranged, omitted, and/or otherwise modified such that other implementations are possible and contemplated.

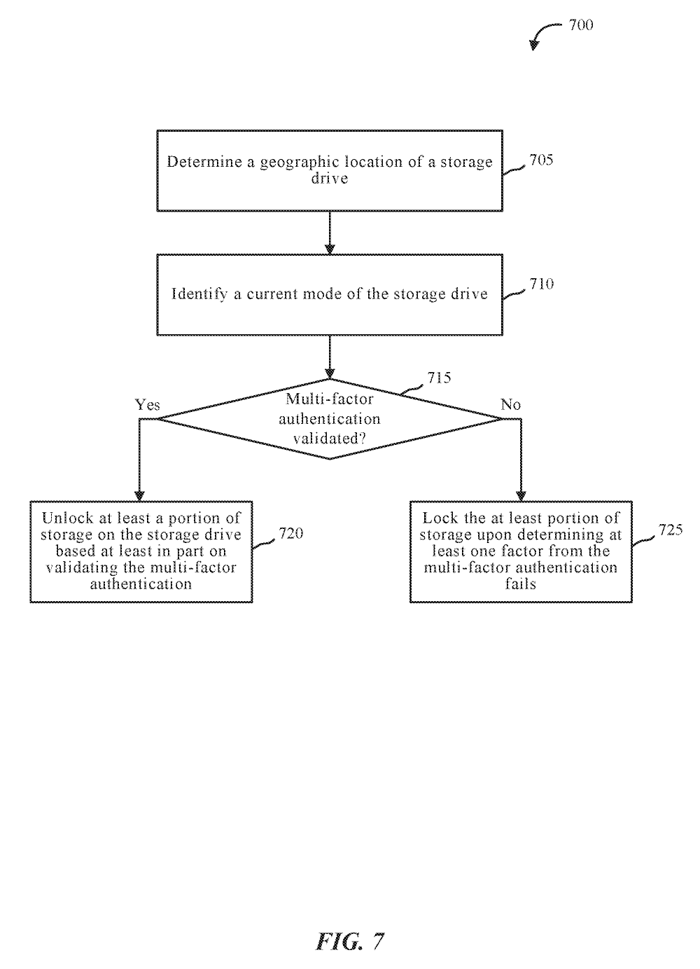

FIG. 7 is a flow chart illustrating an example of a method 700 for location-based security of storage drives, in accordance with various aspects of the present disclosure. One or more aspects of the method 700 may be implemented in conjunction with device 105 of FIG. 1, apparatus 205 of FIG. 2, and/or drive security module 130 depicted in FIGS. 1, 2, 3, and/or 4. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 705, method 700 may include determining a geographic location of the storage drive. At block 710, method 700 may include identifying a current mode of the storage drive. At block 715, method 700 may include determining whether the multi-factor authentication is validated.

In one embodiment, the multi-factor authentication may include verifying the storage drive is located in a permitted area and verifying that the storage drive is within detectable proximity of a pre-authorized device. In some cases, method 700 may include validating the determined location of the storage drive. In some cases, the validating may include a signing of a global positioning system (GPS) packet with a private key and verifying the GPS packet using a public key.

At block 720, method 700 may include unlocking at least a portion of storage on the storage drive upon determining the multi-factor authentication is validated. In some cases, method 700 may unlock the portion of storage based at least in part on the identified current mode of the storage drive. For example, upon determining the current mode indicates the storage drive is already unlocked, method 700 may bypass unlocking the drive when the storage drive is already unlocked.

At block 725, method 700 may include locking the at least portion of storage upon determining at least one factor from the multi-factor authentication fails. In some cases, method 700 may include locking the storage drive upon determining the storage drive is removed from a permitted area or enters a non-permitted area.

The operations at blocks 705-725 may be performed using the drive security module 130 described with reference to FIGS. 1-4 and/or another module. Thus, the method 700 may provide for location-based security of storage drives. It should be noted that the method 700 is just one implementation and that the operations of the method 700 may be rearranged, omitted, and/or otherwise modified such that other implementations are possible and contemplated.

In some examples, aspects from two or more of the methods 600 and 700 may be combined and/or separated. It should be noted that the methods 600 and 700 are just example implementations, and that the operations of the methods 600 and 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, for example, a combination of a DSP and a microprocessor, multiple microprocessors, one or more microprocessors in conjunction with a DSP core, and/or any combination thereof.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC, or A and B and C.

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, or any combination thereof, then the coaxial cable, fiber optic cable, twisted pair, DSL, or wireless technologies such as infrared, radio, and/or microwave are included in the definition of medium. Disk and disc, as used herein, include any combination of compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to storage system applications. In some embodiments, the concepts, the technical descriptions, the features, the methods, the ideas, and/or the descriptions may specifically apply to storage and/or data security system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A storage drive comprising:
a hardware controller configured to:
determine a location of the storage drive;
identify a current mode of the storage drive, the storage drive including at least a secure mode and a non-secure mode;
block activation of the secure mode upon determining that the storage drive is located in one of one or more non-permitted areas or not located in one of one or more permitted areas; and
put the storage drive in the non-secure mode upon determining the storage drive is located in one of the one or more non-permitted areas while in the secure mode.

2. The storage drive of claim 1, wherein the hardware controller is further configured to:
unlock at least a portion of storage on the storage drive based at least in part on determining the storage drive is located in one of the one or more permitted areas.

3. The storage drive of claim 2, wherein the hardware controller is further configured to:
unlock at least the portion of storage on the storage drive upon determining the storage drive is located in one of the one or more permitted areas and within detectable proximity of a pre-authorized device.

4. The storage drive of claim 3, wherein the storage drive or the pre-authorized drive, or both, includes a near field communication (NFC) sensor to detect the proximity between the storage drive and the pre-authorized device.

5. The storage drive of claim 3, wherein the hardware controller is further configured to:
unlock the at least portion of storage on the storage drive based at least in part on validating a multi-factor authentication.

6. The storage drive of claim 5, wherein at least one factor in the multi-factor authentication includes placing the storage drive within detectable proximity of the pre-authorized device.

7. The storage drive of claim 2, wherein the hardware controller is further configured to:
lock the at least portion of storage upon determining the storage drive is removed from one of the one or more permitted areas or enters one of the one or more non-permitted areas.

8. The storage drive of claim 1, wherein the hardware controller is further configured to:
update an event ledger upon detecting the location of the storage drive, wherein the event ledger is stored in a blockchain of a cloud storage system.

9. The storage drive of claim 1, wherein the hardware controller is further configured to:
program the one or more permitted areas or the one or more non-permitted areas, or both, at a manufacturing site of the storage drive;
disable at least one of the permitted areas programmed at the manufacturing site or at least one of the non-permitted areas programmed at the manufacturing site, or both; and
program at least one user customized permitted area, or at least one user customized non-permitted area, or both.

10. The storage drive of claim 1, wherein the hardware controller is further configured to:
validate the determined location of the storage drive, the validating including signing a global positioning system (GPS) packet with a private key and verifying the GPS packet using a public key.

11. A method to improve a storage system, the method comprising:
determining a location of the storage drive;
identifying a current mode of the storage drive, the storage drive including at least a secure mode and a non-secure mode;
blocking activation of the secure mode upon determining that the storage drive is located in one of one or more non-permitted areas or not located in one of one or more permitted areas; and
putting the storage drive in the non-secure mode upon determining the storage drive is located in one of the one or more non-permitted areas while in the secure mode.

12. The method of claim 11, comprising:
unlocking at least a portion of storage on the storage drive based at least in part on determining the storage drive is located in one of the one or more permitted areas.

13. The method of claim 12, comprising:
unlocking at least the portion of storage on the storage drive upon determining the storage drive is located in one of the one or more permitted areas and within detectable proximity of a pre-authorized device.

14. The method of claim 13, the storage drive or the pre-authorized drive, or both, including a near field communication (NFC) sensor to detect the proximity between the storage drive and the pre-authorized device.

15. The method of claim 13, comprising:
unlocking the at least portion of storage on the storage drive based at least in part on validating a multi-factor authentication.

16. The method of claim 15, wherein at least one factor in the multi-factor authentication includes placing the storage drive within detectable proximity of the pre-authorized device.

17. The method of claim 12, comprising:
locking the at least portion of storage upon determining the storage drive is removed from one of the one or more permitted areas or enters one of the one or more non-permitted areas.

18. The method of claim 11, comprising:
updating an event ledger upon detecting the location of the storage drive, wherein the event ledger is stored in a blockchain of a cloud storage system.

19. A computer-program product to improve a storage system, the computer-program product comprising a non-transitory computer-readable medium storing instructions thereon, the instructions being executable by one or more processors to perform the steps of:
determining a location of the storage drive;
validating the determined location of the storage drive;
identifying a current mode of the storage drive, the storage drive including at least a secure mode and a non-secure mode;
blocking activation of the secure mode upon determining that the storage drive is located in one of one or more non-permitted areas or not located in one of one or more permitted areas; and
putting the storage drive in the non-secure mode upon determining the storage drive is located in one of the one or more non-permitted areas while in the secure mode.

20. The computer-program product of claim 19, wherein the instructions executed by the one or more processors cause the one or more processors to perform the steps of:
unlocking at least a portion of storage on the storage drive based at least in part on
determining the storage drive is located in one of the one or more permitted areas.
